(19) United States
(12) Patent Application Publication
(10) Pub. No.: US 2024/0292027 A1
(43) Pub. Date: Aug. 29, 2024

(54) AN APPARATUS, A METHOD AND A COMPUTER PROGRAM FOR VIDEO CODING AND DECODING

(71) Applicant: Nokia Technologies Oy, Espoo (FI)

(72) Inventors: Sujeet Shyamsundar MATE, Tampere (FI); Miska Matias HANNUKSELA, Tampere (FI); Emre Baris AKSU, Tampere (FI); Saba AHSAN, Islamabad (PK); Igor Danilo Diego CURCIO, Vimercate (IT); Yu YOU, Tampere (FI)

(21) Appl. No.: 18/572,271

(22) PCT Filed: Jun. 9, 2022
(86) PCT No.: PCT/FI2022/050398

§ 371 Date: Dec. 20, 2023

(30) Foreign Application Priority Data
Jun. 22, 2021 (FI) 20215729

(51) Int. Cl. H04N 19/597

(52) U.S. Cl. CPC H04N 19/597

(57) ABSTRACT

A method comprising: obtaining omnidirectional video media content (800); determining adominant axis for a viewport representation (802); and encoding the omnidirectional video media content by aligning a yaw axis of the omnidirectional video media content with the dominant axis of the viewport representation (804).

### TECHNICAL FIELD

The present invention relates to an apparatus, a method and a computer program for video coding and decoding.

### BACKGROUND

Recently, the development of various multimedia streaming applications, especially 360-degree video or virtual reality (VR) applications, has advanced with big steps. In viewport-adaptive streaming, the bitrate is aimed to be reduced e.g. such that the primary viewport (i.e., the current viewing orientation) is transmitted at the best quality/resolution, while the remaining of 360-degree video is transmitted at a lower quality/resolution. When the viewing orientation changes, e.g. when the user turns his/her head when viewing the content with a head-mounted display (HMD), another version of the content needs to be streamed, matching the new viewing orientation. This typically involves a change of a viewport from a first viewport to a second viewport.

The adaptation of the viewport dependent encoding of the visual content requires the change in encoding of the video. Therein, a repeated change in the encoded region may lead to poor compression efficiency, especially if the viewport change happens in vertical or diagonal direction when equirectangular projection (ERP) from the 3D content to a 2D plane prior to encoding is in use. A vertical or diagonal rotation of ERP pictures is problematic for translational block-based motion of video codecs, wherein a viewport change leads to an insertion of an I-frame, which in turn causes frequent bitrate spikes.

### SUMMARY

Now, an improved method and technical equipment implementing the method has been invented, by which the above problems are alleviated. Various aspects include methods, apparatuses and a computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

A method according to a first aspect comprises obtaining omnidirectional video media content; determining a dominant axis for a viewport representation; and encoding the omnidirectional video media content by aligning a yaw axis of the omnidirectional video media content with the dominant axis of the viewport representation.

An apparatus according to a second aspect comprises means for obtaining omnidirectional video media content; means for determining a dominant axis for a viewport representation; and means for encoding the omnidirectional video media content by aligning a yaw axis of the omnidirectional video media content with the dominant axis of the viewport representation.

An apparatus according to a third aspect comprises at least one processor and at least one memory, said at least one memory stored with computer program code thereon, the at least one memory and the computer program code configured to, with the at least one processor, cause the apparatus at least to perform: obtain omnidirectional video media content; determine a dominant axis for a viewport representation; and encode the omnidirectional video media content by align a yaw axis of the omnidirectional video media content with the dominant axis of the viewport representation.

According to an embodiment, the obtained omnidirectional video media content comprises a first viewpoint representation, and the apparatus comprises means for detecting a need for a change of a viewport of the omnidirectional video media content from the first viewport representation into a second viewport representation; means for determining a dominant axis for the second viewport representation; and means for encoding the omnidirectional video media content by aligning the yaw axis of the omnidirectional video media content with the dominant axis of the second viewport representation.

According to an embodiment, the apparatus comprises means for transmitting the omnidirectional video media content to second apparatus as viewport-dependent delivery.

According to an embodiment, the apparatus comprises means for obtaining an indication of one or more dominant axes in connection with session negotiation.

According to an embodiment, the apparatus comprises means for encoding the omnidirectional video media content into the second viewport representation by including an IDR picture in the beginning of the encoded second viewport representation.

According to an embodiment, the dominant axis is the axis of the most often viewed viewport, determined based on viewing orientation statistics of previous omnidirectional video media content.

According to an embodiment, the apparatus comprises means for indicating support of alignment of the viewport in connection with the session negotiation.

According to an embodiment, the support of alignment of the viewport is indicated in a session description according to Session Description Protocol (SDP) as an attribute for video align with viewport change axis.

According to an embodiment, the indication of one or more dominant axes is configured to be obtained in a reply of the SDP session negotiation from the second apparatus.

According to an embodiment, the indication of one or more dominant axes is configured to be obtained in an RTP stream from the second apparatus.

According to an embodiment, the support of alignment of the viewport is indicated in a session description according to a Hypertext Transfer Protocol (HTTP).

A method according a fourth aspect comprises receiving an omnidirectional video media content encoded as viewport-dependent delivery into at least a first viewport representation; detecting a need for a change of a viewport into a second viewport representation; determining a dominant axis of the second viewport representation; and signaling the dominant axis of the second viewport representation to an apparatus encoding the omnidirectional video media content.

An apparatus according a fifth aspect comprises at least one processor and at least one memory, said at least one memory stored with computer program code thereon, the at least one memory and the computer program code configured to, with the at least one processor, cause the apparatus at least to perform: receive an omnidirectional video media content encoded as viewport-dependent delivery into at least a first viewport representation; detect a need for a change of a viewport into a second viewport representation; determine a dominant axis of the second viewport representation; and signal the dominant axis of the second viewport representation to a second apparatus encoding the omnidirectional video media content.

An apparatus according a sixth aspect comprises: means for receiving an omnidirectional video media content encoded as viewport-dependent delivery into at least a first viewport representation; means for detecting a need for a change of a viewport into a second viewport representation; means for determining a dominant axis of the second viewport representation; and means for signaling the dominant axis of the second viewport representation to a second apparatus encoding the omnidirectional video media content.

According to an embodiment, the dominant axes of one or more second viewport representation is configured to be signaled in a reply to a session description according to Session Description Protocol (SDP) session negotiation received from the second apparatus.

According to an embodiment the dominant axes of one or more second viewport representation is configured to be signaled in an RTP stream as a response to a session description according to Session Description Protocol (SDP) session negotiation received from the second apparatus.

According to an embodiment, the dominant axes of one or more second viewport representation is configured to be signaled in a reply to a Hypertext Transfer Protocol (HTTP) session negotiation received from the second apparatus.

The further aspects relate to apparatuses and computer readable storage media stored with code thereon, which are arranged to carry out the above methods and one or more of the embodiments related thereto.

### BRIEF DESCRIPTION OF THE DRAWINGS

For better understanding of the present invention, reference will now be made by way of example to the accompanying drawings in which:

FIG. 1 shows schematically an electronic device employing embodiments of the invention;

FIG. 2 shows schematically a user equipment suitable for employing embodiments of the invention;

FIGS. 3a and 3b show schematically an encoder and a decoder suitable for implementing embodiments of the invention;

FIG. 4 shows an example of MPEG Omnidirectional Media Format (OMAF) concept;

FIGS. 5a and 5b show two alternative methods for packing 360-degree video content into 2D packed pictures for encoding;

FIG. 6 shows the process of forming a monoscopic equirectangular panorama picture;

FIG. 7 shows the coordinate system of OMAF;

FIG. 8 shows a flow chart of an encoding method according to an embodiment of the invention;

FIG. 9 shows a flow chart of a decoding method according to an embodiment of the invention; and

FIG. 10 shows a schematic diagram of an example multimedia communication system within which various embodiments may be implemented.

### DETAILED DESCRIPTION OF SOME EXAMPLE EMBODIMENTS

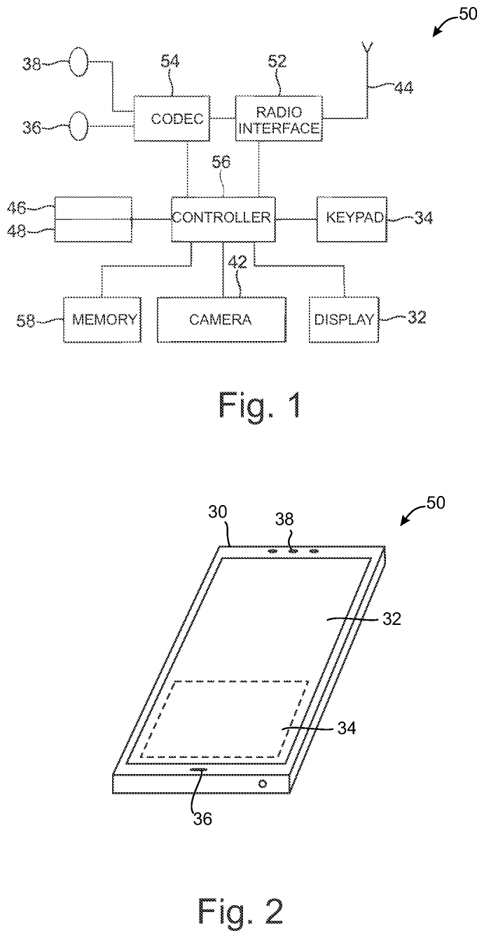

The following describes in further detail suitable apparatus and possible mechanisms for viewpoint switching. In this regard reference is first made to FIGS. 1 and 2, where FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery (or in other embodiments of the invention the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

A video codec consists of an encoder that transforms the input video into a compressed representation suited for storage/transmission and a decoder that can uncompress the compressed video representation back into a viewable form. A video encoder and/or a video decoder may also be separate from each other, i.e. need not form a codec. Typically encoder discards some information in the original video sequence in order to represent the video in a more compact form (that is, at lower bitrate).

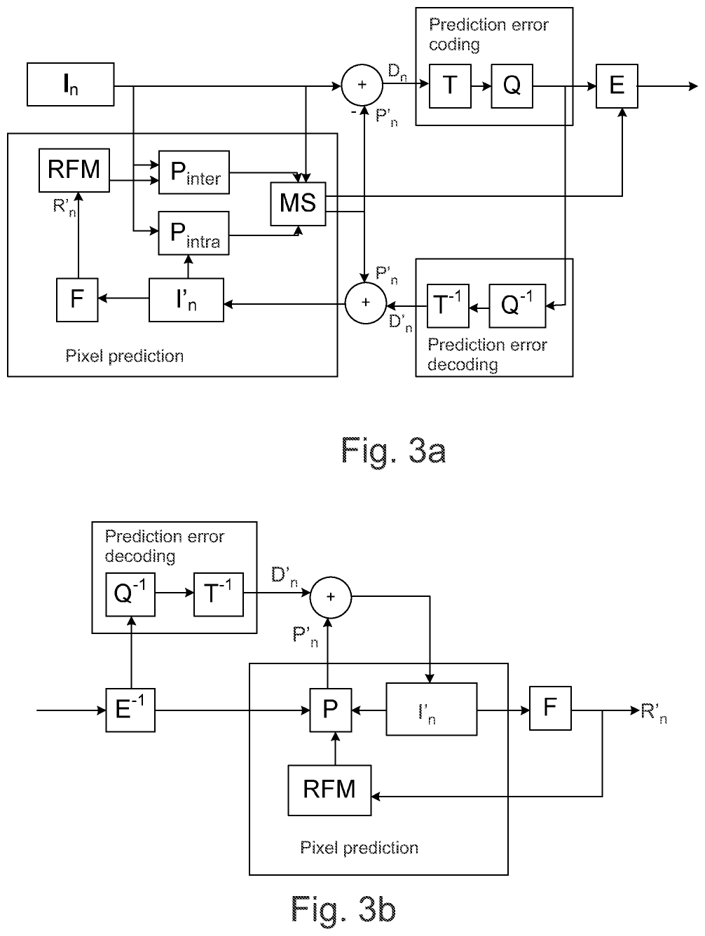

FIGS. 3a and 3b show an encoder and decoder for encoding and decoding the 2D pictures. A video codec consists of an encoder that transforms an input video into a compressed representation suited for storage/transmission and a decoder that can uncompress the compressed video representation back into a viewable form. Typically, the encoder discards and/or loses some information in the original video sequence in order to represent the video in a more compact form (that is, at lower bitrate).

An example of an encoding process is illustrated in FIG. 3a. FIG. 3a illustrates an image to be encoded (In); a predicted representation of an image block (P′n); a prediction error signal (Dn); a reconstructed prediction error signal (D′n); a preliminary reconstructed image (I′n); a final reconstructed image (R′n); a transform (T) and inverse transform (T-1); a quantization (Q) and inverse quantization (Q-1); entropy encoding (E); a reference frame memory (RFM); inter prediction (Pinter); intra prediction (Pintra); mode selection (MS) and filtering (F).

An example of a decoding process is illustrated in FIG. 3b. FIG. 3b illustrates a predicted representation of an image block (P′n); a reconstructed prediction error signal (D′n); a preliminary reconstructed image (I′n); a final reconstructed image (R′n); an inverse transform (T-1); an inverse quantization (Q-1); an entropy decoding (E-1); a reference frame memory (RFM); a prediction (either inter or intra) (P); and filtering (F).

Many hybrid video encoders, such as H.264/AVC encoders, High Efficiency Video Coding (H.265/HEVC a.k.a. HEVC) and Versatile Video Coding (H.266/VVC a.k.a. VVC) encoders, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate). Video codecs may also provide a transform skip mode, which the encoders may choose to use. In the transform skip mode, the prediction error is coded in a sample domain, for example by deriving a sample-wise difference value relative to certain adjacent samples and coding the sample-wise difference value with an entropy coder.

In temporal prediction, the sources of prediction are previously decoded pictures (a.k.a. reference pictures). In intra block copy (IBC; a.k.a. intra-block-copy prediction), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In many video codecs, including H.264/AVC, HEVC and VVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or picture).

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

Available media file format standards include International Standards Organization (ISO) base media file format (ISO/IEC 14496-12, which may be abbreviated ISOBMFF), Moving Picture Experts Group (MPEG)-4 file format (ISO/IEC 14496-14, also known as the MP4 format), file format for NAL (Network Abstraction Layer) unit structured video (ISO/IEC 14496-15) and High Efficiency Video Coding standard (HEVC or H.265/HEVC).

Virtual reality is a rapidly developing area of technology in which image or video content, sometimes accompanied by audio, is provided to a user device such as a user headset (a.k.a. head-mounted display, HMD). As is known, the user device may be provided with a live or stored feed from a content source, the feed representing a virtual space for immersive output through the user device. Compared to encoding and decoding conventional 2D video content, immersive multimedia, such as omnidirectional content consumption, is more complex to encode and decode for the end user. This is due to the higher degree of freedom available to the end user. Currently, many virtual reality user devices use so-called three degrees of freedom (3DoF), which means that the head movement in the yaw, pitch and roll axes are measured and determine what the user sees, i.e. to determine the viewport. This freedom also results in more uncertainty. The situation is further complicated when layers of content are rendered, e.g., in case of overlays.

As used herein the term omnidirectional may refer to media content that has greater spatial extent than a field-of-view of a device rendering the content. Omnidirectional content may for example cover substantially 360 degrees in the horizontal dimension and substantially 180 degrees in the vertical dimension, but omnidirectional may also refer to content covering less than 360 degree view in the horizontal direction and/or 180 degree view in the vertical direction.

Terms 360-degree video or virtual reality (VR) video may sometimes be used interchangeably. They may generally refer to video content that provides such a large field of view that only a part of the video is displayed at a single point of time in typical displaying arrangements. For example, VR video may be viewed on a head-mounted display (HMD) that may be capable of displaying e.g. about 100-degree Field of view. The spatial subset of the VR video content to be displayed may be selected based on the orientation of the HMD. In another example, a typical flat-panel viewing environment is assumed, wherein e.g. up to 40-degree Field-of-view may be displayed. When displaying wide-FOV content (e.g. fisheye) on such a display, it may be preferred to display a spatial subset rather than the entire picture.

MPEG Omnidirectional Media Format (ISO/IEC 23090-2) is a virtual reality (VR) system standard. OMAF defines a media format (comprising both file format derived from ISOBMFF and streaming formats for DASH and MPEG Media Transport). OMAF version 1 supports 360° video, images, and audio, as well as the associated timed text and facilitates three degrees of freedom (3DoF) content consumption, meaning that a viewport can be selected with any azimuth and elevation range and tilt angle that are covered by the omnidirectional content but the content is not adapted to any translational changes of the viewing position.

Standardization of OMAF version 2 (MPEG-I Phase 1b) is ongoing. OMAF v2 is planned to include features like support for multiple viewpoints, overlays, sub-picture compositions, and six degrees of freedom with a viewing space limited roughly to upper-body movements only.

A viewpoint may be defined as the point or space from which the user views the scene; it usually corresponds to a camera position. Slight head motion does not imply a different viewpoint. As used herein the term “observation point or Viewpoint” refers to a volume in a three-dimensional space for virtual reality audio/video acquisition or playback. A Viewpoint is trajectory, such as a circle, a region, or a volume, around the centre point of a device or rig used for omnidirectional audio/video acquisition and the position of the observer's head in the three-dimensional space in which the audio and video tracks are located. In some cases, an observer's head position is tracked and the rendering is adjusted for head movements in addition to head rotations, and then a Viewpoint may be understood to be an initial or reference position of the observer's head. In implementations utilizing DASH (Dynamic adaptive streaming over HTTP), each observation point may be defined as a viewpoint by a viewpoint property descriptor. The definition may be stored in ISOBMFF or OMAF type of file format. The delivery could be HLS (HTTP Live Streaming), RTSP/RTP (Real Time Streaming Protocol/Real-time Transport Protocol) streaming in addition to DASH.

As used herein, the term “random access” may refer to the ability of a decoder to start decoding a stream at a point other than the beginning of the stream and recover an exact or approximate reconstructed media signal, such as a representation of the decoded pictures. A random access point and a recovery point may be used to characterize a random access operation. A random access point may be defined as a location in a media stream, such as an access unit or a coded picture within a video bitstream, where decoding can be initiated. A recovery point may be defined as a first location in a media stream or within the reconstructed signal characterized in that all media, such as decoded pictures, at or subsequent to a recovery point in output order are correct or approximately correct in content, when the decoding has started from the respective random access point. If the random access point is the same as the recovery point, the random access operation is instantaneous; otherwise, it may be gradual.

Random access points enable, for example, seek, fast forward play, and fast backward play operations in locally stored media streams as well as in media streaming. In contexts involving on-demand streaming, servers can respond to seek requests by transmitting data starting from the random access point that is closest to (and in many cases preceding) the requested destination of the seek operation and/or decoders can start decoding from the random access point that is closest to (and in many cases preceding) the requested destination of the seek operation. Switching between coded streams of different bit-rates is a method that is used commonly in unicast streaming to match the transmitted bitrate to the expected network throughput and to avoid congestion in the network. Switching to another stream is possible at a random access point. Furthermore, random access points enable tuning in to a broadcast or multicast. In addition, a random access point can be coded as a response to a scene cut in the source sequence or as a response to an intra picture update request.

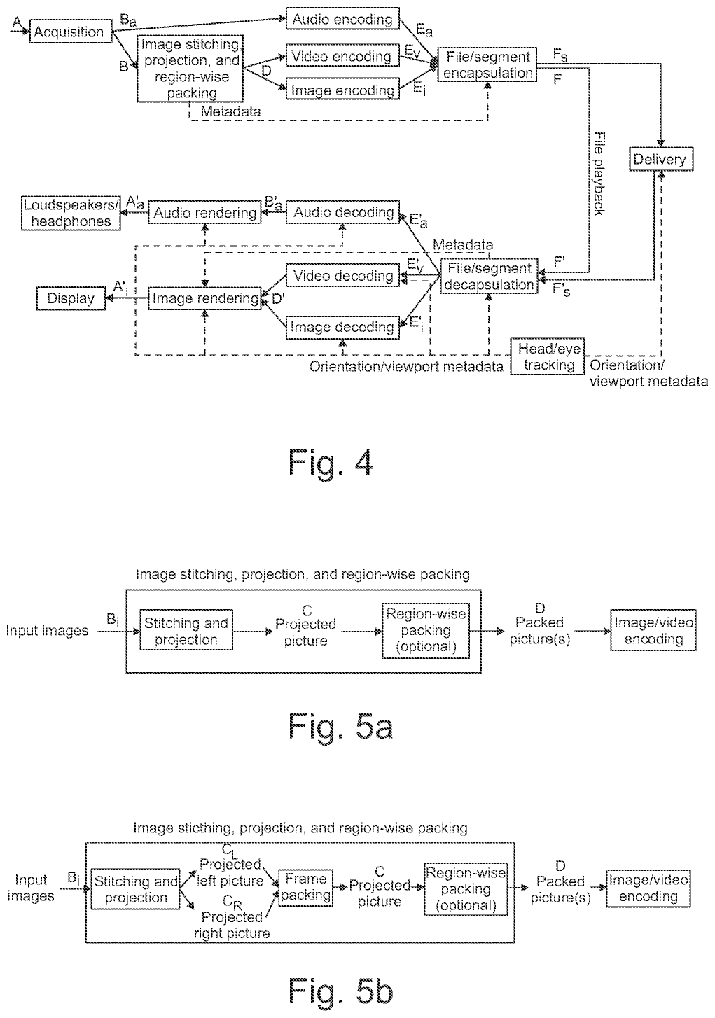

MPEG Omnidirectional Media Format (OMAF) is described in the following by referring to FIG. 4. A real-world audio-visual scene (A) is captured by audio sensors as well as a set of cameras or a camera device with multiple lenses and sensors. The acquisition results in a set of digital image/video (Bi) and audio (Ba) signals. The cameras/lenses typically cover all directions around the center point of the camera set or camera device, thus the name of 360-degree video.

Audio can be captured using many different microphone configurations and stored as several different content formats, including channel-based signals, static or dynamic (i.e. moving through the 3D scene) object signals, and scene-based signals (e.g., Higher Order Ambisonics). The channel-based signals typically conform to one of the loudspeaker layouts defined in CICP. In an omnidirectional media application, the loudspeaker layout signals of the rendered immersive audio program are binaraulized for presentation via headphones.

The images (Bi) of the same time instance are stitched, projected, and mapped onto a packed picture (D).

For monoscopic 360-degree video, the input images of one time instance are stitched to generate a projected picture representing one view. The breakdown of image stitching, projection, and region-wise packing process for monoscopic content is illustrated with FIG. 5a and described as follows. Input images (Bi) are stitched and projected onto a three-dimensional projection structure that may for example be a unit sphere. The projection structure may be considered to comprise one or more surfaces, such as plane(s) or part(s) thereof. A projection structure may be defined as three-dimensional structure consisting of one or more surface(s) on which the captured VR image/video content is projected, and from which a respective projected picture can be formed. The image data on the projection structure is further arranged onto a two-dimensional projected picture (C). The term projection may be defined as a process by which a set of input images are projected onto a projected frame. There may be a pre-defined set of representation formats of the projected picture, including for example an equirectangular projection (ERP) format and a cube map projection (CMP) format. It may be considered that the projected picture covers the entire sphere.

Optionally, region-wise packing is then applied to map the projected picture onto a packed picture. If the region-wise packing is not applied, the packed picture is identical to the projected picture, and this picture is given as input to image/video encoding. Otherwise, regions of the projected picture are mapped onto a packed picture (D) by indicating the location, shape, and size of each region in the packed picture, and the packed picture (D) is given as input to image/video encoding. The term region-wise packing may be defined as a process by which a projected picture is mapped to a packed picture. The term packed picture may be defined as a picture that results from region-wise packing of a projected picture.

In the case of stereoscopic 360-degree video, the input images of one time instance are stitched to generate a projected picture representing two views, one for each eye. Both views can be mapped onto the same packed picture, as described below in relation to the FIG. 5b, and encoded by a traditional 2D video encoder. Alternatively, each view of the projected picture can be mapped to its own packed picture, in which case the image stitching, projection, and region-wise packing is like described above with the FIG. 5a. A sequence of packed pictures of either the left view or the right view can be independently coded or, when using a multiview video encoder, predicted from the other view.

The breakdown of image stitching, projection, and region-wise packing process for stereoscopic content where both views are mapped onto the same packed picture is illustrated with the FIG. 5b and described as follows. Input images (Bi) are stitched and projected onto two three-dimensional projection structures, one for each eye. The image data on each projection structure is further arranged onto a two-dimensional projected picture (C_{L} for left eye, C_{R} for right eye), which covers the entire sphere. Frame packing is applied to pack the left view picture and right view picture onto the same projected picture. Optionally, region-wise packing is then applied to the pack projected picture onto a packed picture, and the packed picture (D) is given as input to image/video encoding. If the region-wise packing is not applied, the packed picture is identical to the projected picture, and this picture is given as input to image/video encoding.

The image stitching, projection, and region-wise packing process can be carried out multiple times for the same source images to create different versions of the same content, e.g. for different orientations of the projection structure. Similarly, the region-wise packing process can be performed multiple times from the same projected picture to create more than one sequence of packed pictures to be encoded.

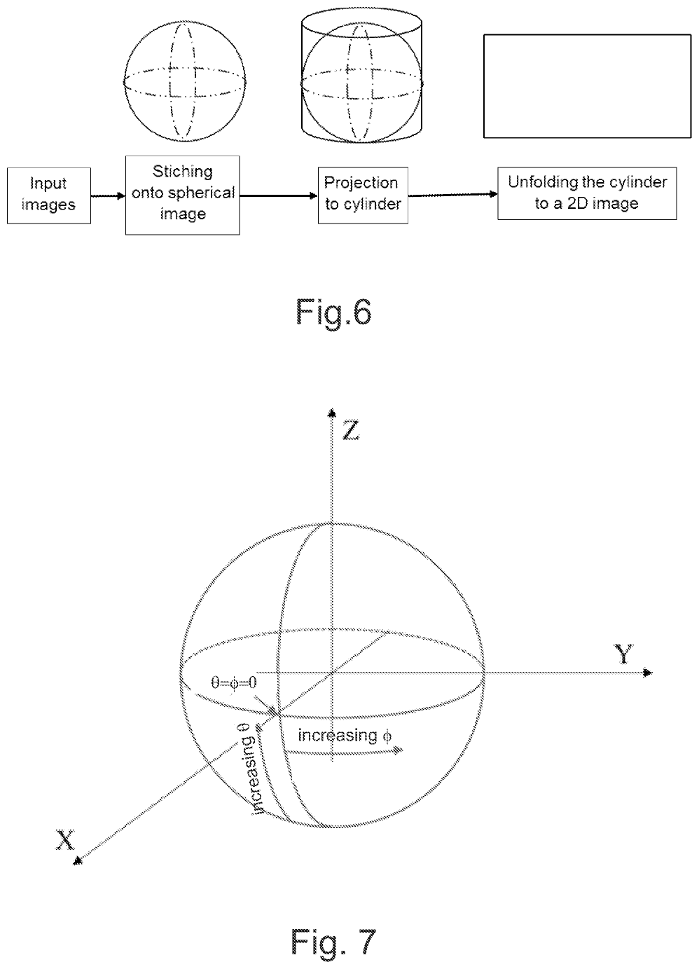

360-degree panoramic content (i.e., images and video) cover horizontally the full 360-degree Field-of-view around the capturing position of an imaging device. The vertical field-of-view may vary and can be e.g. 180 degrees. Panoramic image covering 360-degree Field-of-view horizontally and 180-degree Field-of-view vertically can be represented by a sphere that can be mapped to a bounding cylinder that can be cut vertically to form a 2D picture (this type of projection is known as equirectangular projection). The process of forming a monoscopic equirectangular panorama picture is illustrated in FIG. 6. A set of input images, such as fisheye images of a camera array or a camera device with multiple lenses and sensors, is stitched onto a spherical image. The spherical image is further projected onto a cylinder (without the top and bottom faces). The cylinder is unfolded to form a two-dimensional projected frame. In practice one or more of the presented steps may be merged; for example, the input images may be directly projected onto a cylinder without an intermediate projection onto a sphere. The projection structure for equirectangular panorama may be considered to be a cylinder that comprises a single surface.

In general, 360-degree Content can be mapped onto different types of solid geometrical structures, such as polyhedron (i.e. a three-dimensional solid object containing flat polygonal faces, straight edges and sharp corners or vertices, e.g., a cube or a pyramid), cylinder (by projecting a spherical image onto the cylinder, as described above with the equirectangular projection), cylinder (directly without projecting onto a sphere first), cone, etc. and then unwrapped to a two-dimensional image plane.

In some cases panoramic content with 360-degree horizontal field-of-view but with less than 180-degree vertical field-of-view may be considered special cases of panoramic projection, where the polar areas of the sphere have not been mapped onto the two-dimensional image plane. In some cases a panoramic image may have less than 360-degree horizontal field-of-view and up to 180-degree vertical field-of-view, while otherwise has the characteristics of panoramic projection format.

OMAF allows the omission of image stitching, projection, and region-wise packing and encode the image/video data in their captured format. In this case, images D are considered the same as images Bi and a limited number of fisheye images per time instance are encoded.

For audio, the stitching process is not needed, since the captured signals are inherently immersive and omnidirectional.

The stitched images (D) are encoded as coded images (Ei) or a coded video bitstream (Ev). The captured audio (Ba) is encoded as an audio bitstream (Ea). The coded images, video, and/or audio are then composed into a media file for file playback (F) or a sequence of an initialization segment and media segments for streaming (Fs), according to a particular media container file format. In this specification, the media container file format is the ISO base media file format. The file encapsulator also includes metadata into the file or the segments, such as projection and region-wise packing information assisting in rendering the decoded packed pictures.

The metadata in the file may include:
the projection format of the projected picture,
fisheye video parameters,
the area of the spherical surface covered by the packed picture,
the orientation of the projection structure corresponding to the projected picture relative to the global coordinate axes,
region-wise packing information, and
region-wise quality ranking (optional).

The segments Fs are delivered using a delivery mechanism to a player.

The file that the file encapsulator outputs (F) is identical to the file that the file decapsulator inputs (F′). A file decapsulator processes the file (F′) or the received segments (F′s) and extracts the coded bitstreams (E′a, E′v, and/or E′i) and parses the metadata. The audio, video, and/or images are then decoded into decoded signals (B′a for audio, and D′ for images/video). The decoded packed pictures (D′) are projected onto the screen of a head-mounted display or any other display device based on the current viewing orientation or viewport and the projection, spherical coverage, projection structure orientation, and region-wise packing metadata parsed from the file. Likewise, decoded audio (B′a) is rendered, e.g. through headphones, according to the current viewing orientation. The current viewing orientation is determined by the head tracking and possibly also eye tracking functionality. Besides being used by the renderer to render the appropriate part of decoded video and audio signals, the current viewing orientation may also be used the video and audio decoders for decoding optimization.

The process described above is applicable to both live and on-demand use cases.

The human eyes are not capable of viewing the whole 360 degrees space, but are limited to a maximum horizontal and vertical FoVs (HHFOV, HVFoV). Also, a HMD device has technical limitations that allow only viewing a subset of the whole 360 degrees space in horizontal and vertical directions (DHFOV, DVFoV)).

At any point of time, a video rendered by an application on a HMD renders a portion of the 360 degrees video. This portion is defined here as viewport. A viewport may be defined as a region of omnidirectional image or video suitable for display and viewing by the user. A current viewport (which may be sometimes referred simply as a viewport) may be defined as the part of the spherical video that is currently displayed and hence is viewable by the user(s). At any point of time, a video rendered by an application on a head-mounted display (HMD) renders a portion of the 360-degrees video, which is referred to as a viewport. Likewise, when viewing a spatial part of the 360-degree Content on a conventional display, the spatial part that is currently displayed is a viewport. A viewport is a window on the 360-degree world represented in the omnidirectional video displayed via a rendering display. A viewport may be characterized by a horizontal field-of-view (VHFoV) and a vertical field-of-view (VVFoV). In the following, the horizontal field-of-view of the viewport will be abbreviated with HFoV and, respectively, the vertical field-of-view of the viewport will be abbreviated with VFoV.

A sphere region may be defined as a region on a sphere that may be specified by four great circles or by two azimuth circles and two elevation circles and additionally by a tile angle indicating rotation along the axis originating from the sphere origin passing through the center point of the sphere region. A great circle may be defined as an intersection of the sphere and a plane that passes through the center point of the sphere. A great circle is also known as an orthodrome or Riemannian circle. An azimuth circle may be defined as a circle on the sphere connecting all points with the same azimuth value. An elevation circle may be defined as a circle on the sphere connecting all points with the same elevation value.

The coordinate system of OMAF, as shown in FIG. 7, consists of a unit sphere and three coordinate axes, namely the X (back-to-front) axis, the Y (lateral, side-to-side) axis, and the Z (vertical, up) axis, where the three axes cross at the centre of the sphere. In case the omnidirectional video content is rotational in 3DoF, the rotational movements around the X, Y, and Z axes may be referred to as pitch, yaw, and roll, respectively. The location of a point on the sphere is identified by a pair of sphere coordinates azimuth (ϕ) and elevation (θ).

3GPP has standardized Multimedia Telephony Service for IMS (MTSI), and a terminal according to MTSI, i.e. a MTSI terminal, may support the Immersive Teleconferencing and Telepresence for Remote Terminals (ITT4RT) feature, which is currently being standardized. MTSI clients supporting the ITT4RT feature may be referred to as ITT4RT clients.

ITT4RT functionality for MTSI enables support of an immersive experience for remote terminals joining teleconferencing and telepresence sessions. It addresses scenarios with two-way audio and one-way immersive 360-degree video, e.g., a remote single user wearing an HMD participating in a conference will send audio and optionally 2D video (e.g., of a presentation, screen sharing and/or a capture of the user itself), but receives stereo or immersive voice/audio and immersive 360-degree video captured by an omnidirectional camera in a conference room connected to a fixed network.

Since immersive 360-degree video support for ITT4RT is unidirectional, ITT4RT clients supporting immersive 360-degree video are further classified into two types to distinguish between the capabilities for sending or receiving immersive video: (i) ITT4RT-Tx client, which is an ITT4RT client only capable of sending immersive 360-degree video, and (ii) ITT4RT-Rx client, which is an ITT4RT client only capable of receiving immersive 360-degree video.

For a more detailed description of ITT4RT, a reference is made to a 3GPP draft standard document “Support Immersive Teleconferencing and Telepresence for Remote Terminals (ITT4RT)”, Rel-17, 21 Mar. 2021.

Omnidirectional video may be applied in versatile scene monitoring/surveillance in industrial IoT (Internet-of-Things) applications, for example utilizing an ITT4RT-Tx client and an ITT4RT-Rx client. Omnidirectional cameras may be installed with such IOT/surveillance applications implemented in a ITT4RT-Tx client so that desired region of the space can be monitored with a high degree of flexibility. The ITT4RT-Tx client may then send the captured and encoded omnidirectional video to the ITT4RT-Rx client for displaying and/or analysing.

Viewport-dependent delivery may be applied for low-latency delivery such that the content delivery adapts to the viewport orientation (e.g., to enable higher quality in the viewport compared to the other part). As described above, the omnidirectional content is typically transformed into a 2D format so that it can be encoded by any conventional video codec (e.g., HEVC, VVC, etc.).

The adaptation of the viewport dependent encoding of the visual content requires the change in encoding of the video. Therein, a repeated change in the encoded region may lead to poor compression efficiency, especially if the viewport change happens in vertical or diagonal direction when equirectangular projection (ERP) is in use. A vertical or diagonal rotation of ERP pictures is problematic for translational block-based motion of video codecs, wherein a viewport change leads to an insertion of an I-frame, which in turn causes frequent bitrate spikes.

Now an improved method for viewport-dependent delivery is introduced in order to at least alleviate the above problems.

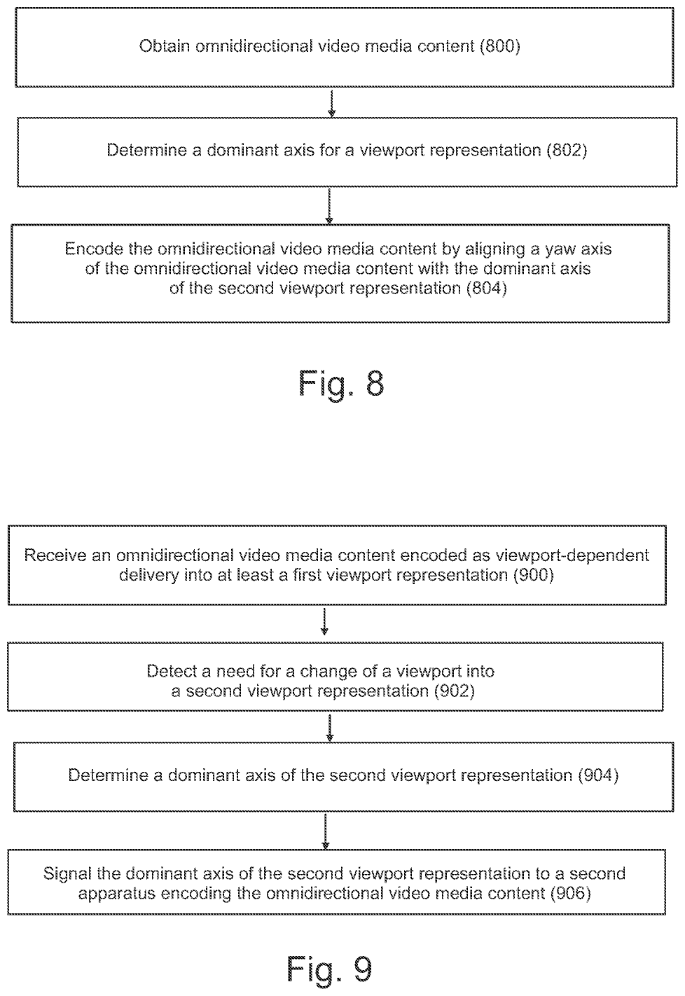

The method according to an aspect, as shown in FIG. 8, comprises obtaining (800) omnidirectional video media content; determining (802) a dominant axis for a viewport representation; and encoding the omnidirectional video media content by aligning (804) a yaw axis of the omnidirectional video media content with the dominant axis of the viewport representation.

The dominant axis for the viewport, as used herein, refers to the trajectory, according to which the viewport change is predominantly expected to happen. The dominant axis for a viewport change may be determined, for example, based on the region of interest which needs to be monitored by change in viewport. Determining the dominant axis for a viewport change may be especially useful in, but not limiting to, IoT surveillance or monitoring applications, for example, determining the expected trajectory for a viewport change for surveillance of a pathway visible in a shop, an industrial conveyor belt, etc.

Thus, the encoding apparatus, such as an ITT4RT-Tx client, may operate as a stand-alone device in terms of determining the dominant axis for a viewport change and aligning the yaw axis of the omnidirectional video media content with the dominant axis of the viewport representation, for example, by automatically determining a direction of a most predominantly monitored region/object-of-interest (ROI/OOI) from the omnidirectional video media content, and the setting the direction as the dominant axis, according to which the alignment of the yaw axis of the omnidirectional video media content shall be carried out.

According to an embodiment, the obtained omnidirectional video media content comprises a first viewpoint representation, and the method comprises detecting a need for a change of a viewport of the omnidirectional video media content from the first viewport representation into a second viewport representation; determining a dominant axis for the second viewport representation; and encoding the omnidirectional video media content by aligning a yaw axis of the omnidirectional video media content with the dominant axis of the second viewport representation.

Thus, upon a change of a viewport from a first viewpoint representation into a second viewport representation, the dominant axis of the change-to (i.e. the second) viewport is determined and the yaw axis of the omnidirectional captured video is the aligned with the dominant axis of viewport change. This results in predominantly horizontal change in the viewports, which is easier to handle for the conventional 2D video codecs, especially when equirectangular projection (ERP) is used as the projection of the omnidirectional video media content into 2D plane. The horizontal changes in the viewports reduce the number of inserted I-frames in comparison to vertical or diagonal viewport changes and consequently leads to reduction in bitrate spikes and improved encoding efficiency.

According to an embodiment, the method comprises transmitting the omnidirectional video media content to second apparatus as viewport-dependent delivery.

The method is well suited, for example, in IoT surveillance or monitoring applications, where an ITT4RT-Tx client (a.k.a. a first apparatus or a sender apparatus) is configured to capture omnidirectional video media content and encode it into at least a first viewport representation for viewport-dependent delivery to an ITT4RT-Rx client (a.k.a. a second apparatus or a receiver apparatus) configured to render the surveillance or monitoring video data for analysis and/or display. Thus, the second apparatus may indicate the desired dominant axis to the first device, which then changes the viewport accordingly. It is noted that detecting the need for the change of the viewport into the second viewport representation in the first apparatus does not necessarily require any control from the second apparatus, but the change may take place e.g. according to a predetermined scheme, for example such that the whole 360 degree surroundings of the first apparatus, or only regions-of-interest therein, are captured by sequentially by changing the viewport.

It is nevertheless noted that the method and the embodiments related thereto are not limited to only ITT4RT compliant user equipment, but they are also applicable to any conversational omnidirectional video transmission between a sender and a receiver device.

According to an embodiment, the method comprises obtaining an indication of one or more dominant axes in connection with session negotiation. Hence, the receiver (the second) apparatus may select the appropriate dominant axes and signal them to the sender (the first) apparatus during the session negotiation. During the session, the dominant axis can be modified if the monitoring requirement changes, for example if signaled by the receiver (the second) apparatus.

The videoconference session may be established using session protocols, e.g. SDP (Session Description Protocol) and SIP (Session Initiation Protocol). Thus, in the above embodiment, the indication of the one or more dominant axes may be obtained as a SDP offer in connection with a SIP/SDP session setup and negotiation, or as any suitable session parameter description in case of a webRTC (Web Real-Time Communication) user equipment. Signalling the appropriate dominant axes from the receiver (the second) apparatus may to the sender (the first) apparatus may take place as part of the SDP answer in SIP/SDP session setup and negotiation. Modifications of the dominant axis during the session may be signalled by the receiver (the second) apparatus by a SIP session re-negotiation in case of SIP/SDP enabled UEs.

According to an embodiment, the method comprises encoding the omnidirectional video media content into the second viewport representation by including an IDR picture in the beginning of the encoded second viewport representation. Thus, while the alignment of the yaw axis of the omnidirectional captured with the indicated dominant axis of the second viewport significantly reduces the need for IDR pictures, the operation of the decoder requires that the bitstream includes IDR pictures at certain intervals. Therefore, the dominant axis change may occasionally result in introduction of an IDR picture into the encoded bitstream.

According to an embodiment, the dominant axis is the axis of the most often viewed viewport(s), determined based on viewing orientation statistics of previous omnidirectional video media content. Thus the embodiment is especially applicable to on-demand/live streaming, e.g., in case of content which has been consumed by many users earlier or content analyzed for expected viewport change trajectories, where a first version of an omnidirectional video content is made available for viewing at one or more second (receiving) apparatus. The one or more second (receiving) apparatus may view the omnidirectional video content from all desired directions by the changing the viewport, wherein the second apparatus or its user may pay attention to certain regions of objects of interest, e.g for analysis purposes. Viewing orientation statistics of the first version are collected, and the dominant axis of viewport change is determined based on the viewing orientation statistics as the most often viewed viewport.

Especially in on-demand/live streaming applications, the first (sender) apparatus may then rotate the omnidirectional video content to align the yaw axis of the omnidirectional captured video with the dominant axis of viewport change, and a second version may by prepared from the rotated omnidirectional video content and made available for viewing by the second (receiver) apparatus. The viewing orientation statistics and dominant axis determination may be performed separately per each IDR picture period.

In the following, various embodiments for indicating the one or more dominant axis to the first (sender) apparatus for the alignment of the yaw axis are described more in detail.

According to an embodiment, the method comprises indicating support of alignment of the viewport in connection with the session negotiation.

In case of a conversational or low latency video call, a session description, such as a session description according to Session Description Protocol (SDP), may indicate the support of the first (sender) apparatus for video alignment. Subsequently, the rotation information signaling (i.e. the one or more dominant axes) may be performed via the session description during session setup. The support can be indicated as a new attribute called “video align with viewport change axis” or in short “video-align-vca”. During the session setup offer-answer negotiation, the second (receiver) apparatus may indicate the rotation information.

Thus, the first (sender) apparatus may start the session negotiation with an indication of the support for video alignment, and the second (receiver) apparatus may reply with a value of rotation in SDP. According to another embodiment, the second (receiver) apparatus may reply so as to retain the video-align-vca attribute in the session without the rotation value(s). In such a case, the second (receiver) apparatus may add the rotation value(s) later, e.g. via a session re-negotiation.

In another embodiment, the sender may offer the video-align-vca but the rotation value is signaled as part of the RTP stream, where an SEI (Supplemental Enhancement Information) message together with the video NALU may be added to indicate the rotation value. It is also possible to use two SEI messages, one to enable recentering in case of viewport dependent delivery and the other to enable reverse rotation, where an order or additional label can be defined to disambiguate between the two SEI messages. As a further option, it is possible to add the rotation information as a RTP header extension.

In yet another embodiment, an SDP with video-align-vca already carries the rotation information with the SDP offer, and the receiver UE can accept the offer as such, in which case the SDP response will carry the same rotation value. If the receiver UE is already aware of the rotation values for different purposes, it can already modify the rotation information of the offer in the answer with the desired rotation values.

Below is an example of SDP session description, where the first (sender) apparatus and the second (receiver) apparatus have agreed on the parameters video-align-vca and rotation:

```
m=video 49154 RTP/AVP 98 100 99
mid=100
a=tcap:1 RTP/AVPF
a=pcfg:1 t=1
b=AS:950
b=RS:0
b=RR:5000
/*omni video of room A*/
a=rtpmap:100 H265/90000
a=3gpp_360video:100 cap:VDP; sm=Mono; cfov:[x=360,y=180] proj:ERP
a=fmtp:100 profile-id=1; level-id=93;
sprop-vps=QAEMAf//AWAAAAMAgAAAAwAAAwBdLAUg;
  sprop-sps=QgEBAWAAAAMAgAAAAWAAAwBdoAKAgC0WUuS0i9AHcIBB;
  sprop-pps=RAHAcYDZIA==
a=imageattr:100 send [x=7680,y=4320] recv [x=1280,y=720]
/*video-align-vca indicates support, rotation indicates the yaw,
pitch, roll values*/
a=video-align-vca:rotation=[100,90,80]
a=rtcp-fb:* trr-int 5000
a=rtcp-fb:* nack
a=rtcp-fb:* nack pli
a=rtcp-fb:* ccm fir
a=rtcp-fb:* ccm tmmbr
a=rtcp-fb:* viewport freq=30*
```

Another example of SDP session description is given below, where the first (sender) apparatus and the second (receiver) apparatus have agreed on the parameters video-align-vca and rotation with the additional flexibility of having the rotation value delivered as part of the RTCP feedback message indicated by a=rtcp-fb:* rotation or as an extension to the viewport feedback:

```
m=video 49154 RTP/AVP 98 100 99
mid=100
a=tcap:1 RTP/AVPF
a=pcfg:1 t=1
b=AS:950
b=RS:0
b=RR:5000
/*omni video of room A*/
a=rtpmap:100 H265/90000
a=3gpp_360video:100 cap:VDP; sm=Mono; cfov:[x=360,y=180] proj:ERP
a=fmtp:100 profile-id=1; level-id=93;
sprop-vps=QAEMAf//AWAAAAMAgAAAAwAAAwBdLAUg;
  sprop-sps=QgEBAWAAAAMAgAAAAwAAAwBdoAKAgC0WUuS0i9AHcIBB;
  sprop-pps=RAHAcYDZIA==
a=imageattr:100 send [x=7680,y=4320] recv [x=1280,y=720]
/*video-align-vca indicates support, rotation indicates the yaw,
pitch, roll values*/
a=video-align-vca:rotation=[100,90,80]
a=rtcp-fb:* trr-int 5000
a=rtcp-fb:* nack
a=rtcp-fb:* nack pli
a=rtcp-fb:* ccm fir
a=rtcp-fb:* ccm tmmbr
/*only one of the two RTCP feedback is required at the same time,
they are both indicated in the SDP for concise representation*/
a=rtcp-fb:* video_align_rotation
```

According to an embodiment, a new feedback message is defined which carries exactly one rotation value for aligning the omnidirectional video yaw axis with the viewport change axis.

According to an embodiment, the method comprises carrying out an analysis of the omnidirectional video media content about regions-of-interest or objects-of-interest in the content; assigning one or more candidate viewport axis for the regions-of-interest or the objects-of-interest found in the content; and signaling the one or more candidate viewport axis for selection.

Thus, multiple candidate viewport change axes may be determined by the first (sender) apparatus based on visual scene analysis and signaled to the second (receiver) apparatus for selection. In such a case, the different viewport change axes may have indicators which enables the second (receiver) apparatus to appropriately select the viewport change axis of interest. The information or semantic meaning of the different viewport change axes is done via a URL (e.g., HTTP URL).

An example of SDP session description is given below for indicating video alignment support with multiple candidate viewport change axes:

```
m=video 49154 RTP/AVP 98 100 99
mid=100
a=tcap:1 RTP/AVPF
a=pcfg:1 t=1
b=AS:950
b=RS:0
b=RR:5000
/*omni video of room A*/
a=rtpmap:100 H265/90000
a=3gpp_360video:100 cap:VDP; sm=Mono; cfov:[x=360,y=180] proj:ERP
a=fmtp:100 profile-id=1; level-id=93;
sprop-vps=QAEMAf//AWAAAAMAgAAAAwAAAwBdLAUg;
  sprop-sps=QgEBAWAAAAMAgAAAAwAAAwBdoAKAgC0WUuS0i9AHcIBB;
  sprop-pps=RAHAcYDZIA==
a=imageattr:100 send [x=7680,y=4320] recv [x=1280,y=720]
/*video-align-vca indicates multiple viewport change alignment
options*/
a=video-align-vca:rotation=[100,90,80]:AssemblyLine1
a=video-align-vca:rotation=[140,90,70]:AssemblyLine2
a=video-align-vca:rotation=[175,90,90]:AssemblyLine3
a=rtcp-fb:* trr-int 5000
a=rtcp-fb:* nack
a=rtcp-fb:* nack pli
a=rtcp-fb:* ccm fir
a=rtcp-fb:* ccm tmmbr
a=rtcp-fb:* viewport freq=30*
```

In case of conversational or low latency delivery, the changes in the axes may occur as run-time based on client request via session renegotiation or RTCP feedback. Such a change may be controlled e.g. with Full Intra Request (FIR) together with the axes information signaled by the second (receiver) apparatus.

In case of streaming scenarios, a manifest file, such as a Media Presentation Description (MPD), may carry additional viewpoint information for content selection indicating the dominant axis for retrieval. The additional viewpoint information can be the rotation with respect to a default viewpoint. This information may be referred to as ViewportChangeAlignmentRotationStruct( ), which can be carried in the viewpoint information structure of an OMAF viewpoint. The viewpoint descriptor in OMAFv2 can be extended to include additional parameter “VCARotationStruct” and a viewport change description. The viewport change description enables the second (receiver) apparatus or an OMAF player to determine which of the OMAF viewpoint adaptation sets are suitable for a particular task requiring viewport change.

An example of an extension for the viewpoint structure description, as described in clause 7.12.1 in OMAFv2 FDIS, is given below:

```
aligned(8) ViewpointInformationStruct(groupDescrIncludedFlag,
urlIncludedFlag)
{
  unsigned int(1) gpspos_present_flag;
  unsigned int(1) geomagnetic_info_present_flag;
  unsigned int(1) switching_info_present_flag;
  unsigned int(1) looping_present_flag;
  bit(4) reserved = 0;
  ViewpointPosStruct( );
  ViewpointGroupStruct(groupDescrIncludedFlag);
  ViewpointGlobalCoordinateSysRotationStruct( );
  if(gpspos_present_flag)
    ViewpointGpsPositionStruct( );
  if(geomagnetic_info_present_flag)
    ViewpointGeomagneticInfoStruct( );
  if(viewpoint_alignment_vca_info_present_flag)
    ViewpointAlignmentVCAInfoStruct( );
  if(switching_info_present_flag)
    ViewpointSwitchingListStruct(urlIncludedFlag);
  if(looping_present_flag)
    Viewpoint LoopingStruct( );
}
```

Herein, viewpoint_alignment_vca_info_present_flag equal to 1 indicates that ViewpointAlignmentVCAStruct( ) is present. Viewpoint_alignment_vca_info_present_flag equal to 0 indicates that ViewpointAlignmentVCAStruct( ) is not present. viewpoint_alignment_vca_info_present_flag should be equal to 1 for a viewpoint to enable alignment of the viewpoint yaw axis to align with the viewpoint change axis.

```
aligned(8) ViewpointAlignmentVCAStruct( ){
  unsigned int(8) num_vca_alignment;
  for(i=0;i<num_vca_alignment;i++){
    utf8string num_vca_label;
    signed int(32) viewpoint_alignment_yaw;
    signed int(32) viewpoint_alignment_pitch;
    signed int(32) viewpoint_alignment_roll;
  }
}
```

Herein, viewpoint_alignment_yaw, viewpoint_alignment_pitch, and viewpoint_alignment_roll specify the yaw, pitch, and roll angles, respectively, of the rotation angles of X, Y, Z axes of the common reference coordinate system relative to the geomagnetic North direction, in units of 2⁻¹⁶ degrees. viewpoint_alignment_yaw shall be in the range of −180*2⁻¹⁶ to 180*2⁻¹⁶−1, inclusive. viewpoint_alignment_pitch shall be in the range of −90*2⁻¹⁶ to 90*2⁻¹⁶, inclusive. viewpoint_alignment_roll shall be in the range of −180*2⁻¹⁶ to 180*2⁻¹⁶−1, inclusive.

In the above implementation example, each num_vca_label indicates one viewpoint change axis. The above structure may be included in a timed metadata track in case of time varying information.

The embodiments relating to the encoding aspects may be implemented in an apparatus, such as an ITT4RT-Tx client, comprising means for obtaining omnidirectional video media content; means for determining a dominant axis for a viewport representation; and means for encoding the omnidirectional video media content by aligning a yaw axis of the omnidirectional video media content with the dominant axis of the viewport representation.

The embodiments relating to the encoding aspects may likewise be implemented in an apparatus comprising at least one processor and at least one memory, said at least one memory stored with computer program code thereon, the at least one memory and the computer program code configured to, with the at least one processor, cause the apparatus at least to perform: obtain omnidirectional video media content; determine a dominant axis for a viewport representation; and encode the omnidirectional video media content by aligning a yaw axis of the omnidirectional video media content with the dominant axis of the viewport representation.

Another aspect relates to the operation of second (receiving) apparatus, such as an ITT4RT-Rx client, when performing the above-described embodiments.

The operation may include, as shown in FIG. 9, receiving (900) an omnidirectional video media content encoded as viewport-dependent delivery into at least a first viewport representation; detecting (902) a need for a change of a viewport into a second viewport representation; determining (904) a dominant axis of the second viewport representation; and signaling (906) the dominant axis of the second viewport representation to an apparatus encoding the omnidirectional video media content.

Hence, the second (receiving) apparatus, such as an ITT4RT-Rx client, may receive the omnidirectional video media content encoded by the first (sender) apparatus and delivered as viewport-dependent delivery configured to display a first viewport representation. The second (receiving) apparatus detects a need to change the viewport into a second viewport representation, and it may determine a dominant axis of the second viewport representation. The dominant axis of the second viewport representation is then signaled to the first (sender) apparatus so as to cause the first (sender) apparatus to change the viewport accordingly.

As described above, the dominant axes of one or more second viewport representation may be configured to be signaled, according to an embodiment, in a reply to a session description according to Session Description Protocol (SDP) session negotiation received from the second apparatus.

According another embodiment, the dominant axes of one or more second viewport representation may be configured to be signaled in an RTP stream as a response to a session description according to Session Description Protocol (SDP) session negotiation received from the second apparatus, as described above.

According another embodiment, the support of alignment of the viewport is indicated in a session description according to a Hypertext Transfer Protocol (HTTP).

The embodiments relating to the decoding aspects may be implemented in an apparatus comprising: means for receiving an omnidirectional video media content encoded as viewport-dependent delivery into at least a first viewport representation; means for detecting a need for a change of a viewport into a second viewport representation; means for determining a dominant axis of the second viewport representation; and means for signaling the dominant axis of the second viewport representation to an apparatus encoding the omnidirectional video media content.

The embodiments relating to the decoding aspects may likewise be implemented in an apparatus comprising at least one processor and at least one memory, said at least one memory stored with computer program code thereon, the at least one memory and the computer program code configured to, with the at least one processor, cause the apparatus at least to perform: receive an omnidirectional video media content encoded as viewport-dependent delivery into at least a first viewport representation; detect a need for a change of a viewport into a second viewport representation; determine a dominant axis of the second viewport representation; and signal the dominant axis of the second viewport representation to an apparatus encoding the omnidirectional video media content.

Such apparatuses may comprise e.g. the functional units disclosed in any of the FIGS. 1, 2, 3a and 3b for implementing the embodiments.

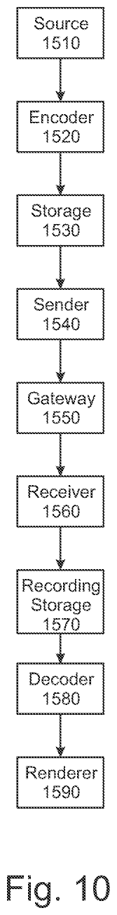

FIG. 10 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be decoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530, which may be e.g. a buffer of the first (sender) apparatus. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. Other options include RTP payload format encapsulation or RTP header extension delivered over UDP. Other transport protocols such as QUIC/SCTP may also be possibly used.

If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

It is noted that especially in case of conversational omnidirectional video delivery, the server 1540, in addition to the gateway 1550, may be implemented as a MCU (Multiparty Conferencing Unit)/MRF (Media Resource Function). According to an, the alignment is performed by the MRF/MCU depending on the expected viewport change trajectories for each of the receiver UEs. Thus the dominant axis to align the omnidirectional yaw angle can be configured depending on each receiver UE requirements.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random access memory. The format of the coded media bitstream in the recording storage 1570 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. Herein, the decoder should be interpreted to cover any operational unit capable to carry out the decoding operations, such as a player, a receiver, a gateway, a demultiplexer and/or a decoder.

If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1570 is discussed to simplify the description without a lack of generality

The coded media bitstream may be processed further by a decoder 1570, whose output is one or more uncompressed media streams. Finally, a renderer 1590 may reproduce the uncompressed media streams with a loudspeaker or a display, for example. The receiver 1560, recording storage 1570, decoder 1570, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

A decoder 1580 may be configured to perform switching between different representations e.g. for switching between different viewports of 360-degree video content, viewpoint switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Thus, the decoder may comprise means for requesting at least one decoder reset picture of the second representation for carrying out bitrate adaptation between the first representation and a third representation. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, where the example embodiments have been described with reference to an encoder, it needs to be understood that the resulting bitstream and the decoder may have corresponding elements in them. Likewise, where the example embodiments have been described with reference to a decoder, it needs to be understood that the encoder may have structure and/or computer program for generating the bitstream to be decoded by the decoder.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the coder and decoder may share some or all common elements.

Although the above examples describe embodiments of the invention operating within a codec within an electronic device, it would be appreciated that the invention as defined in the claims may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-19. (canceled)

20. A method comprising:
obtaining an omnidirectional video media content;
determining a dominant axis for a viewport representation; and
encoding the omnidirectional video media content by aligning a yaw axis of the omnidirectional video media content with the dominant axis of the viewport representation.

21. An apparatus comprising at least one processor and at least one memory, said at least one memory stored with computer program code thereon, the at least one memory and the computer program code configured to, with the at least one processor, cause the apparatus at least to:
obtain an omnidirectional video media content;
determine a dominant axis for a viewport representation; and
encode the omnidirectional video media content by aligning a yaw axis of the omnidirectional video media content with the dominant axis of the viewport representation.

22. The apparatus according to claim 21, wherein the obtained omnidirectional video media content comprises a first viewpoint representation, and the apparatus is further caused to:
detect a need for a change of a viewport of the omnidirectional video media content from the first viewport representation into a second viewport representation;
determine a dominant axis for the second viewport representation; and
encode the omnidirectional video media content by aligning the yaw axis of the omnidirectional video media content with the dominant axis of the second viewport representation.

23. The apparatus according to claim 21, wherein the apparatus is further caused to transmit the omnidirectional video media content to a second apparatus as viewport-dependent delivery.

24. The apparatus according claim 21, wherein the apparatus is further caused to obtain an indication of one or more dominant axes in connection with session negotiation.

25. The apparatus according to claim 21, wherein the apparatus further caused to encode the omnidirectional video media content into the second viewport representation by including an IDR picture in the beginning of the encoded second viewport representation.

26. The apparatus according to claim 21, wherein the dominant axis is an axis of a most often viewed viewport, determined based on viewing orientation statistics of previous omnidirectional video media content.

27. The apparatus according to claim 24, wherein the apparatus is further caused to indicate support of alignment of the viewport in connection with the session negotiation.

28. The apparatus according to claim 27, wherein the support of alignment of the viewport is indicated in a session description according to session description protocol (SDP), as an attribute for video, align with viewport change axis.

29. The apparatus according to claim 28, wherein the indication of one or more dominant axes is configured to be obtained in a reply of the SDP session negotiation from the second apparatus.

30. The apparatus according to claim 28, wherein the indication of one or more dominant axes is configured to be obtained in an Real-time Transport Protocol (RTP) stream from the second apparatus.

31. The apparatus according to claim 27, wherein the support of alignment of the viewport is indicated in a session description according to a hypertext transfer protocol (HTTP).

32. A method comprising:
receiving an omnidirectional video media content encoded as viewport-dependent delivery into at least a first viewport representation;
detecting a need for a change of a viewport into a second viewport representation;
determining a dominant axis of the second viewport representation; and
signaling the dominant axis of the second viewport representation to an apparatus encoding the omnidirectional video media content.

33. The method according to claim 32, wherein the dominant axis of one or more second viewport representation is configured to be signaled in a reply to a session description according to session description protocol (SDP) session negotiation received from the second apparatus.

34. The method according to claim 32, wherein the dominant axis of one or more second viewport representation is configured to be signaled in an Real-time Transport Protocol (RTP) stream as a response to a session description according to Session Description Protocol (SDP) session negotiation received from the second apparatus.

35. The method according to claim 32, wherein the dominant axis of one or more second viewport representation is configured to be signaled in a reply to a hypertext transfer protocol (HTTP) session negotiation received from the second apparatus.

36. An apparatus comprising at least one processor and at least one memory, said at least one memory stored with computer program code thereon, the at least one memory and the computer program code configured to, with the at least one processor, cause the apparatus at least to:
receive an omnidirectional video media content encoded as viewport-dependent delivery into at least a first viewport representation;
detect a need for a change of a viewport into a second viewport representation;
determine a dominant axis of the second viewport representation; and
signal the dominant axis of the second viewport representation to a second apparatus encoding the omnidirectional video media content.

37. The apparatus according to claim 34, wherein the dominant axis of one or more second viewport representation is configured to be signaled in a reply to a session description according to Session Description Protocol (SDP) session negotiation received from the second apparatus.

38. The apparatus according to claim 34, wherein the dominant axis of one or more second viewport representation is configured to be signaled in an Real-time Transport Protocol (RTP) stream as a response to a session description according to Session Description Protocol (SDP) session negotiation received from the second apparatus.

39. The apparatus according to claim 34, wherein the dominant axis of one or more second viewport representation is configured to be signaled in a reply to a Hypertext Transfer Protocol (HTTP) session negotiation received from the second apparatus.
